(19) United States
(12) Patent Application Publication
(10) Pub. No.: US 2025/0341307 A1
(43) Pub. Date: Nov. 6, 2025

(54) CONDUCTIVE/NON-CONDUCTIVE COMPOSITE HEATER FOR STEAM PRODUCTION

(71) Applicants: Ramgopal VISSA, Hyderbad (IN); Sriramu SAJJA, Hyderbad (IN); Venkata BURADA, Cincinnati, OH (US); Jainagesh SEKHAR, Cincinnati, OH (US); MICROPYRETICS HEATERS INTERNATIONAL, INC, Cincinnati, OH (US)

(72) Inventors: Ramgopal VISSA, Hyderbad (IN); Sriramu SAJJA, Hyderbad (IN); Venkata BURADA, Cincinnati, OH (US); Jainagesh SEKHAR, Cincinnati, OH (US)

(73) Assignee: MHI Health Devices, Cincinnati, OH (US)

(21) Appl. No.: 18/867,041

(22) PCT Filed: Jun. 12, 2023
(86) PCT No.: PCT/US2023/025018

§ 371 Date: Nov. 19, 2024

Related U.S. Application Data
(60) Provisional application No. 63/397,620, filed on Aug. 12, 2022.

(51) Int. Cl. F22B 1/28; H05B 6/12

(52) U.S. Cl. CPC F22B 1/284; H05B 6/12; H05B 2203/003

(57) ABSTRACT

Presented is an apparatus and method to produce steam wherein conductive elements and non-conductive artifacts are present and interact during the generation of steam allowing for the elimination of the critical heat flux (CFH) limitations present during the production of high-temperature steam.

### CROSS-REFERENCE TO RELATED APPLICATIONS

This application claims the benefit of U.S. provisional applications 63/397,620 entitled “Macro/Micro-Composite Heater for Steam Production” filed on Aug. 12, 2022, the disclosure of which is incorporated by reference herein in its entirety. This application also contains references to U.S. patent application Ser. No. 17/916,078 entitled “Energy Efficient Twin Reversed Spiral Configured Heating Element And Gas Heater Using The Same” filed by the inventors on Sep. 20, 2022, which is disclosed by reference in its entirety herein.

### BACKGROUND

Nearly half of the energy produced in the US has a steam-touch component. New steam technology is herein proposed that will have a significant effect on the energy sector by impacting alternative fuel production such as syngas variants, providing ecologically sensitive solutions for high-temperature steam reactions, impacting CO₂ mitigation in a meaningful manner, and significantly improving food security operations. In the past, a severe vapor lock problem has prevented rapid high-temperature steam production. A fundamentally new method is presented to overcome this problem. Preliminary results have provided good support for considering this new method.

The global market for steam boiler systems has been estimated at $18.5 billion in the year 2020 and projected to reach a revised total of $22 billion by 2027. The need for high-temperature steam directly impacts society with several significant mobility and sustainability issues. The presented technology increases energy efficiency and reduces emissions. The technology revealed in this application will a have significant impact on energy savings. With the proposed rapid film boiling technology, energy savings of about 6.4×10¹⁰ Watt-hours/year (64 million kWh); water savings of about 1.5×10¹¹ liters per year; alleviation of safety concerns from pressure-lines and autoclave vessel with the no-pressure, high-temperature steam availability on demand; expansion of scientific investigations in medicine and drug development from the versatility of the new process; and industrial food safety enhancements are all feasible.

High-temperature superheated steam offers high reaction kinetics for waste-to-fuel production strategies. With steam, several hydrocarbons (i.e., plastics) can be converted back to liquid fuel. With ultra-high-temperature steam availability, the Fischer-Tropsch reactions can be used to convert organic waste into usable fuel. The products of the reactions can further be converted to methanol and ethanol. Household waste can also be converted with steam and steam-plasma (a catalyst) to break down organic materials into syngas, a mixture of hydrogen and carbon monoxide. Several important reactions are now being actively considered globally for new fuels, including the steam reforming reaction CH₄ (g)+H₂O (steam)=CO (g)+3H₂ (g) that can happen realistically only above 800° C. The mixture of hydrogen and carbon monoxide from municipal solid waste and other renewable biomass can be converted to long-chain hydrocarbon molecules that make up diesel and jet fuels. A reaction for producing syngas is 2CH₄ (g)+H₂O (steam)+CO₂ (g)=3CO (g)+5H₂ (g) which requires +850° C. may become commercially practical. Thus, high-temperature steam is important for converting CO₂ into useful products.

Thermal gasification of waste materials allows the production of gaseous fuel that can be easily collected and transported. This gasification typically takes place at temperatures from 750°-1100° C. with carbon and steam-containing chemicals. The materials suitable for steam pyrolysis at 1250° C. include coal, animal and human waste, food scraps, paper, cardboard, plastics, and rubber. The presented process and apparatus allow for such required temperatures to be attained economically and in an environmentally friendly manner.

The proposed invention provides a new engineering approach with macro-composite heating systems for rapid high-temperature steam production with close to 100% conversion efficiency. Steam production systems can be classified as belonging to slow, low temperature boilers or rapid steam generators. The competitive environment in the US existing presently consists of only low temperature steam production from traditional boilers. For high-temperature steam, there is no US presence in the competitive market. The main efforts to date are from the applicants who have been able to make pure steam systems to 400° C. by the rapid film boiling method. Steam generator techniques are expected to overtake boiler-based techniques for reasons of simplicity of operations; the smaller footprint of the machines; and instant steam production at high temperatures, which adds to the overall energy efficiency of the generators.

### High-Pressure Boilers:

Boiler technology couples P (saturated) and T (saturated), and therefore a higher temperature always requires a higher pressure. This type of steam technology thus is very limited in the maximum available temperature. Typically, a 3-Bar pressure boiler yields only 132° C. Even a 100 Bar (10 MPa) system can only yield 311° C. Pressure vessels require thick-walled flanges. As such, these vessels are very heavy, requiring huge foundational superstructures. Pressure vessel steam can be further subdivided into (a) combustion-based and (b) electrical electric energy sources. In general, boilers cannot make high-temperature steam as they are limited by the known CHF (Critical Heat Flux) limit—a formation of bubbles that impede heat transfer. The CHF (bubble limit) prevents a steady state heat transfer and leads to low boiling rates.

Combustion boilers make steam with a very low energy conversion efficiency and significantly add to pollution. Historically, the biggest change in boiler design came with the development of the membrane tube wall in the late 1950s and early 1960s. Seamless tubes were welded together in a tube shop, using a membrane steel bar between the tubes, and made into a large tube panel. During the past 100 years, the steam-generating industry has stayed stagnant. Technological advances led to larger boilers, not higher temperature boilers. Pollution concerns and the use of high-quality steam in medical autoclaves led to electrically heated pressure boilers.

Electric boilers that use heating elements to make high-quality steam in a pressure vessel are preferable to combustion boilers but are more expensive. They are cleaner and offer better controls. Transferring heat across a boiler wall for thick boiler steel shells and flanges (required for high temperatures) limits the amount of heat that can be efficiently used for the boiling operation. Thus, even in the best electric boilers (pressure vessels), the efficiency falls below 70% when attempting high-temperature steam. Note that the temperatures are still only around 300° C. or so at best. The market requirement is now for greater than 800° C. steam.

Currently, boiler steam at a temperature of 100° C. costs about $20/1000 Kg for combustion production and over $100/1000 Kg for electric boiler generation plus amortized capital cost. The electric superheated steam from a steam generator costs $60/1000 Kg which is less than electric boiler steam, but more than combustion heated steam compared only to low-temperature steam. However, the real cost of high-temperature steam is much lower because of the much faster reaction kinetics, and hence higher productivity. Note that steam boilers cost over $100,000 for 100 Kg/hr. of steam whereas the simpler steam generators are expected to price out at about a fifth of this number.

There is over a 90% drop in the unit size for the equivalent steam-producing device. From about an average of 200 square feet to less than 10 square feet (for a 20 Kg/hr. system). This is remarkable and in tune with the requirements for industries of “Future Manufacturing” to move closer to urban populations where space is at a premium.

High-Temperature steam is particularly important for food safety and security for a minimum 3-log reduction with steam plasma. The food safety standard is a 3-log reduction in 30 minutes. High-temperature steam (impact 250° C.) was noted to allow 5-log reduction in 4 minutes. What this means is the very high-temperature steam may be quickly moved (rastered) over surfaces to obtain high productivity food security results.

### SUMMARY

Several trials reported in the boiler literature appear to clearly indicate that design configuration changes in heating element materials will never be able to overcome the CHF limit because a higher heat flux leads to a higher wall temperature and to high corrosion and deterioration of the heating element materials. The CHF limit also causes a loss of heat transfer, excessive heater temperatures and possible rapid heater failure. To counter these problems, proposed is novel conductive/non-conductive heating surfaces as the heat transfer surface on which steam will be produced. Preliminary results have shown that this process and apparatus will eliminate the CHF limitation.

### DRAWINGS—FIGURES

FIG. 1 is a depiction of a superheated steam generator.

FIG. 2 shows placement of conductive heating elements placed inside of the superheated steam generator boiler.

FIG. 3 is a cut away view of a superheated steam generator comprised of conductive heating elements and non-conductive artifacts positioned inside of a boiler.

FIG. 4 shows and embodiment of a spiral conductive heating element employed within a superheated steam generator.

FIG. 5 is an array of spiral conductive heating elements.

FIG. 6 is a second embodiment of the placement of a conductive heating element within a superheated steam generator.

FIG. 7 is an alternate conductive heating element embodiment comprising twists and bends of flat stock.

FIG. 8 is an alternate conductive heating element embodiment comprising a square configuration of bent round stock.

DRAWING - REFERENCE NUMERALS

| | | | |
|---|---|---|---|
| 10. | superheated steam generator | 12. | boiler |
| 14. | lid | 16. | base |
| 18. | exhaust | 20. | mounting hinge |
| 22. | instrument port | 24. | flange |
| 26. | conductive element | 28. | non-conductive artifact |
| 30. | conductive/non-conductive | 50. | spiral conductive element |
| | heater | | |
| 52. | spiral element array | 54. | flat conductive element |
| 56. | twisted conductive element | 58. | round stock conductive |
| | | | element |

### DESCRIPTION

This application presents a method and apparatus for the control or elimination of the CHF limitation found in boilers during the steam generation process allowing for the generation of higher temperatures. The process and apparatus utilize conductive heating element material surrounded or in contact with non-conductive material such as ceramic spheres, globules or balls. The placement of these non-conductive artifacts (spheres, etc.) in general contact with the heating elements in a steam generation scenario decrease or even prevent the formation of air bubbles or layers on the conductive heat element surfaces during steam generation. In this application conductive means a state of being electrically charged while non-conductive refers to a state of not being electrically charged, not necessarily a definition of the materials chosen for their composition. The CHF limit is thereby avoided, permitting better heat transfer and higher attainable superheated steam temperatures.

The anticipated apparatus comprises a containment vessel for the generation of steam. The vessel or boiler will contain conductive elements for the heating of water (or other fluids) for the generation of steam (or gas). The conductive elements may be in any desired or necessary shape for the anticipated application or configuration of the containment vessel. Such conductive element shapes may include, but are not limited to, u-shape, straight, grid, square, ribbon or coil. They may be non-spherical in cross-section. Multiple individual conductive elements may be utilized as well in arrayed or stacked configurations.

The non-conductive artifacts may act to physically break up or interrupt the formation of air bubbles by their presence at the surface of the conductive elements. The artifacts also displace water allowing for water savings. The artifacts are movable or free floating within the boiler or steam generating device and offer no spacing or structural support for the conductive elements though they are positioned around, and in some configurations (coiled elements, etc.), within the conductive element. The non-conductive artifacts will self-arrange around the conductive elements according to the movement of the liquid within the apparatus. Since the artifacts are not rigidly fixed and are able to move spatially they can contact each other (vibrate) and strike evolving CHF bubbles and preemptively prevent CHF issues while not shorting out any conductive member. In addition to the transfer of momentum due to buoyancy and surface tension gradient forces of the non-conductive artifacts motion may be imparted to the artifacts because of emf forces, static forces and mechanical or vibrational forces directly from the conductive elements.

The conductive elements may also be designed to self-arrange by being free-floating. Free-floating conductive elements and non-conductive artifacts may not be joined or attached by mechanical means but could act to support each other dynamically. In other embodiments it is anticipated that the conductive elements may be mechanically affixed with the artifacts floating among them.

Again, the non-conductive artifacts, or “gravel”, act to disperse or break up the formation of air bubble or layers in contact with the conductive elements. The non-conductive objects also assist in increasing the life of the boiler vessel and conductive elements by absorption of corrosive ions and prevention of erosion caused by cavitation due to CHF. The surface textures and compositions of both the artifacts and conductive elements may be designed in a manner to prevent CHF limiting conditions as well. In practice, the presence of non-conducting artifacts enables high current densities that would otherwise lead to CHF.

The described method and apparatus save water and energy in the production of steam. By using the non-conductive artifacts within the boiler, the amount of water used is decreased. Up to 90% of volume of the artifacts and fluid may be comprised of the artifacts. The conductor and nonconductor may have a porosity ranging from 1-40%. With less water, less energy will be needed to superheat the water and less time will be needed to complete the process. Using conductive elements, the electric heating production of steam will require smaller steam generators with fewer regulatory requirements. Such a system allows for the production of steam from any temperature up to 1500° C.

### DETAILED DESCRIPTION

In one anticipated embodiment, the application anticipates an electrically charged heating element comprised of flat, round or other shaped element material stock that is formed into a grid, coil or spiral pattern in a flat orientation. The flat orientation refers to an element configuration of a grid, coil or spiral that predominately forms a plane in a single direction. The plane will be comprised of the grid, coil or spiral pattern formed by the manipulation of the element stock. The conductive element may then be positioned within a boiler housing and immersed in properly treated water (de-ionized, meta-free, etc.) or other fluid. The conductive heating elements may be comprised of a metallic material containing at least one of aluminum, iron, nickel, copper, carbon, chromium, tantalum, titanium, cobalt, mixtures, and alloys thereof or semiconductor material.

Any standard or typical boiler may be equipped with the described conductive elements and non-conductive artifacts. The artifacts by their positioning and subsequent movement due to heating may assist in the breaking up or dispersal of bubbles or bubble layer surrounding the conductive heating elements. In this manner, CHF limitations are avoided allowing for the production of higher temperature steam with less water and energy usage. Less water is required since a considerable portion of the volume of the boiler vessel may be taken up by the non-conductive artifacts. The elimination of CHF may allow higher temperatures produced by less power. The application of such conductive elements and non-conductive artifacts are also contemplated in other applications such as heat and plasma generators or non-standard or typical boilers. It is anticipated that the boiler may include a fluid phase change device. This type of high-volume continuous heating assembly for steam or gas can be used for boilers with vessels designed for up to hundreds of bars of back-pressure yet allows Psat and Tsat decoupling for optimized steam production.

In boilers and other steam production systems the element material may be constructed of conductive material and may be part of a heating system also comprising non-conductive artifacts (ceramic spheres, etc.) positioned between and around the element material. The artifacts are free-floating and provide no spacing or structural support to the element material. The artifacts may be comprised of an oxide, nitride, phosphide, sulfide, carbide, carbonitride, oxycarbide and mixtures, and alloys wherein any metallic material contains at least one of aluminum, iron, nickel, copper, carbon, chromium, tantalum, titanium, cobalt, or a semiconductor material.

As stated above, a preferred embodiment of the disclosed heating element is comprised of a length of material that is wound in a spiral in either a clockwise or counter-clockwise or both directions mostly inwardly. The winding is begun after a length of element material is established as a terminal that extends outwardly from the surface of the spiral. The initial winding of the material continues inward to a point near the center of the spiral where it reverses direction and then is wound in a spiral outwardly in the same plane as the initial spiral and between the initial spirals until it is outside of the initial spiral where it is terminated by the formation of a second terminal extending from the surface of the spiral. The terminals are attached to an electrical power source.

The spiral may be comprised of any suitable heating element material. The element may be comprised of flat stock having a length, width and depth with the flat stock being wound in a spiral parallel to the length dimension, across the width dimension and perpendicular to the depth dimension. Round stock and other geometries are contemplated as well. It has been found that twin spirals provide opposing magnetic fields in the element spiral which gives auto stability.

A preferred embodiment of the disclosed twin spiral heating element comprises a first terminal perpendicular to the outer surface of the spiral. Where the first terminal meets the spiral heating element stock, which in this embodiment is flat stock, the flat stock is wound in a spiral configuration inwardly in a counter-clockwise direction in line with the length of the flat stock in an initial spiral. The winding in the counter-clockwise direction continues to a point near the center of the spiraled element forming a central void. At this point the flat stock reverses itself, possibly in a u-turn, or spiral reversal or other configuration, and is wound in a spiral configuration outwardly in a clockwise direction in a secondary or return spiral, between, opposed to and in the same plane as the windings of the initial spiral. The clockwise winding continues outwardly until the outside of the initial spiral is reached. The initial spirals and secondary spirals are in a single plane. The return spiral ends in a second terminal projecting in a perpendicular direction out from the surface of the spiral heating element stock. The terminals may project out from the stock at any position relative to each other and may project at angles other than the perpendicular where they connect to a power supply.

A spiral interface is defined between the initial spiral and the return spiral. There may be non-conductive ceramic (or other material) artifacts positioned between the spirals in the interface. The spiral pitch of the spirals may vary between 4.5 mm and 5.5 mm. The distance between the spirals may also vary, but a suggested embodiment has a distance of 12 mm.

The disclosed spiraled elements may be used individually or in multiples in an array with series or parallel connections. In an array the multiple twin reversed spiral elements are stacked side by side and may be stacked or arranged side by side at an offset and inverse to one another (clockwise start next to a counter-clockwise start). It has been found that such an arrangement creates a reticulate honeycomb structure which acts to break up any laminar flow and creates a high turbulent flow resulting in a higher heat transfer coefficient. In a contemplated embodiment the individual heating element spirals are positioned at a 30° to 60° offset in plane and also out of plane. Other offsets at different angles are contemplated as well as different combinations of clockwise spiral start and counter-clockwise spiral start in the element array.

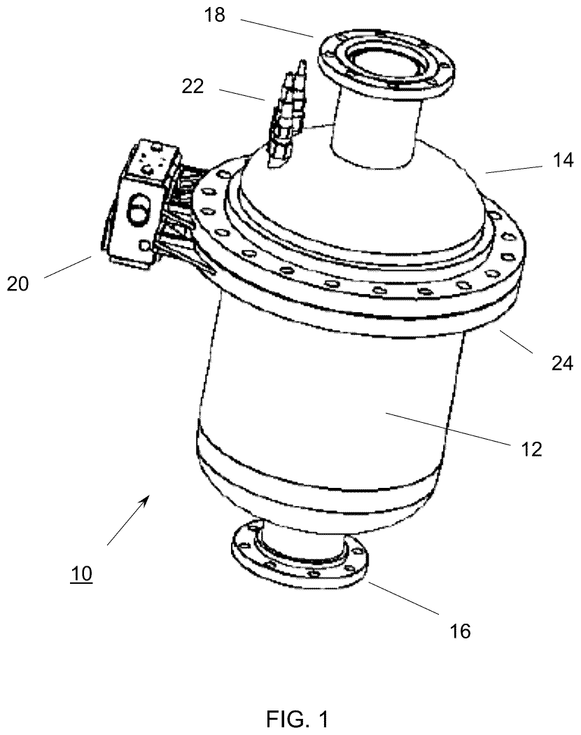

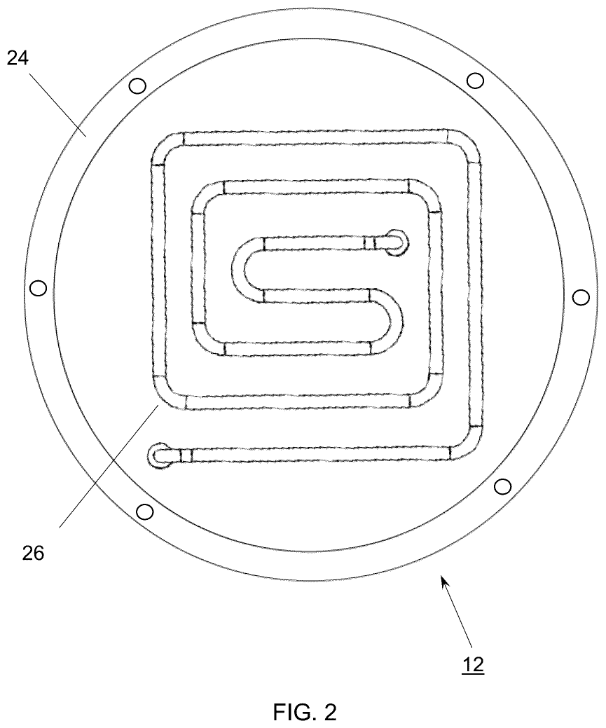

FIG. 1 is an example of an embodiment of a superheated steam generator 10 comprising in part a boiler 12, lid 14, base 16 and mounting hinge 20. The lid 14 is comprised of an exhaust 18 for produced superheated steam and multiple instrument ports 22 which may provide access to the interior of the boiler 12 for thermocouples, sensors, controls, fills or power lines. In some embodiments the base 16 may provide such access. The mounting hinge 20 connects the lid 14 to the flange 24 of the boiler 12 permitting the lid 14 to be swung free from the boiler 12. Bolts or clamps may be used to affix the lid 14 to the boiler 12 when in operation. The boiler 12 is intended to heat water to generate steam or heat other fluids to generate vapor. FIG. 2 shows the interior of the boiler 12 containing an electrically conductive heating element 26. In operation water placed inside of the sealed boiler 12 would be heated by the conductive element 26 converting it to steam. However, the temperatures achievable by such a system are limited by bubble formation (Critical Heat Flux (CHF) limitation.

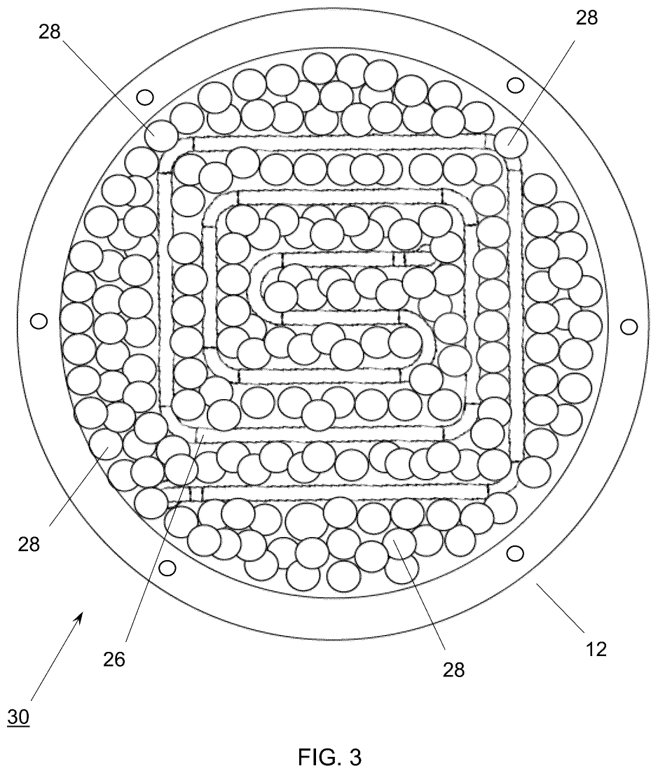

FIG. 3 shows the interior of a boiler 12 containing a conductive element 26 and a plurality of non-conductive artifacts 28 surrounding the conductive heater 26. The non-conductive artifacts 28 depicted in FIG. 3 are spherical but may be any desired shape including but not limited to cylinders, platonic solid and tessellations. The conductive element 26 and the non-conductive artifact 28 may be continuous or discontinuous. They may also be in any convenient or necessary size or number to attain a desired volume in the boiler or other heating chamber. A volume of artifacts 28 of up to 90% of the chamber is anticipated. In other embodiments the volume of the non-conductive artifacts 28 may exceed that of the conductive element 26. Also, the volume of the artifact 28 may range from 0.1 to 10 times of a volume of liquid to be vaporized or transformed. Different types and orientations of conductive heating elements 26 may dictate the shape and size of the artifacts 28 for the artifacts 28 to be positioned within and around the coils or bends of an element 26. The artifacts 28 are not attached to the conductive element 26 or to the inside of the boiler 12. The artifacts 28 are self-supporting and free-floating in the liquid in the boiler 12 with respect to and around the element 26. The artifacts 28 may have a porosity of from 1-40%.

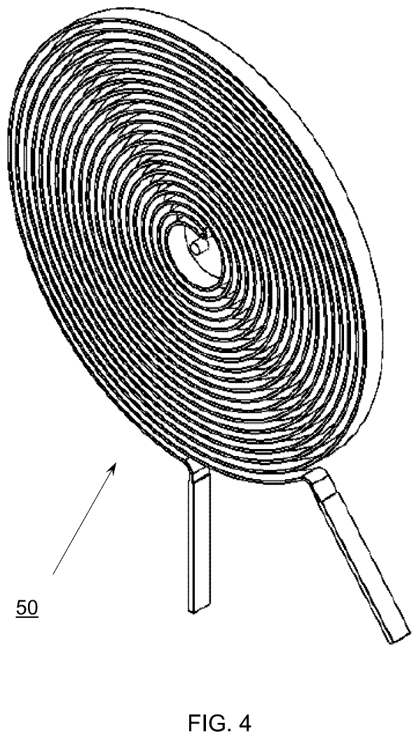

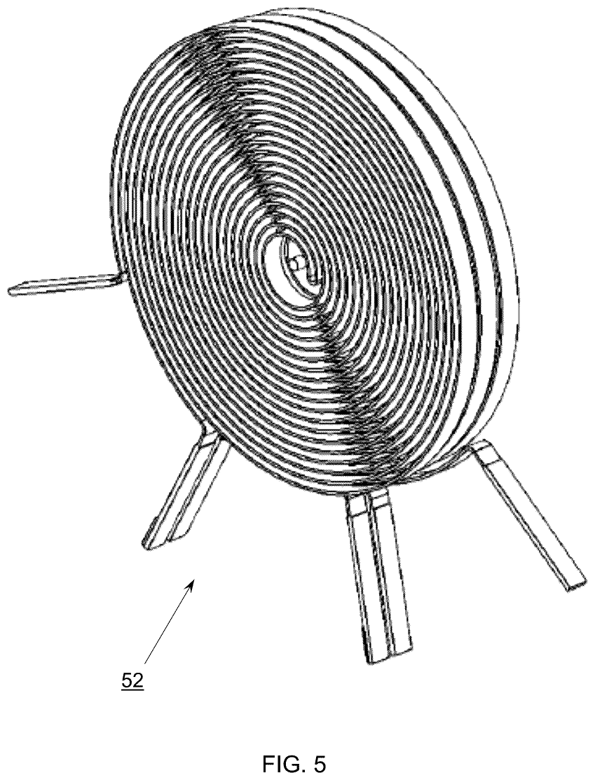

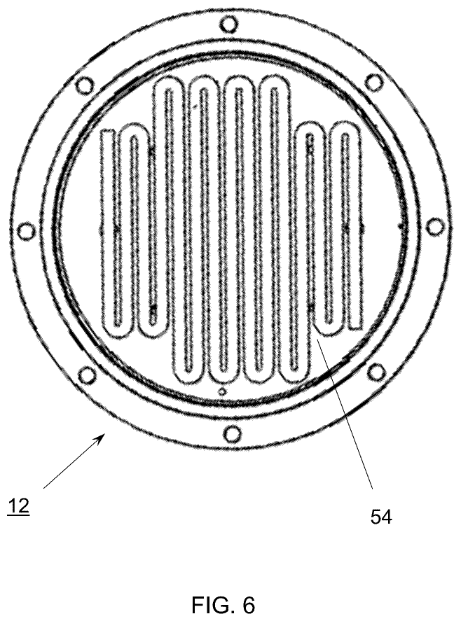

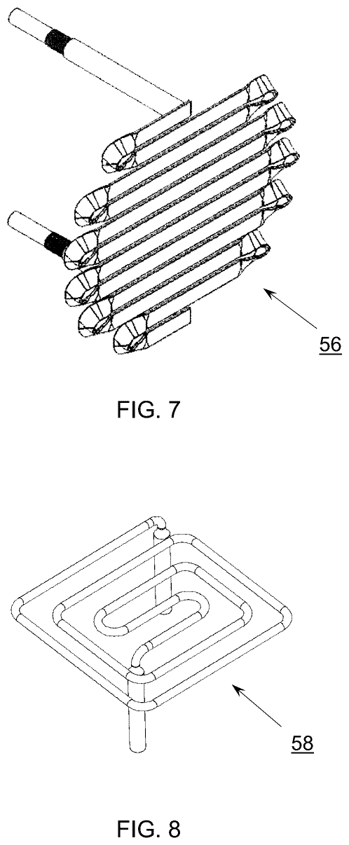

It is anticipated that the conductive heater 26 area in contact with the fluid may be less than 0.93 square meters. FIGS. 4-8 show different configurations of conductive elements 26 that may be used with the artifacts 28 to comprise a conductive/non-conductive heater 30. Specifically anticipated shapes include, but are not limited to, spiral element 50, flat element 54, twisted element 56 and round stock element 58. Such elements may be used singly or in stacked multiple arrays as shown in the spiral array 52 of FIG. 5. Other arrangements of multiple elements 26 are anticipated including side-by-side placement and off-set stacked arrays. The conductive elements in a stacked array in a multiple use may be controlled or charged individually by independent or intelligent controls if desired.

In operation, as the liquid is heated in the boiler 12 by the conductive heating element 26 imparting movement to the liquid and the free-floating artifacts 28. The movement of the artifacts around and between the conductive element 26 act to disrupt the formation of bubbles or act to break up formed bubbles within the boiler 12 thereby countering the CHF limitation and allowing the attaining of greater temperatures within the boiler and increasing the efficiency of steam or vapor generation. It is envisioned that such a conductive/non-conductive heater 30 may be employed in any electrically powered steam generator whether pressurized and sealed or not.

Although preferred embodiments of the conductive/non-conductive heater and method are presented in the above specification, the scope of the invention is not to be limited by them. Other heater configurations, applications and equivalents are anticipated by the applicants such as means to disperse bubbles without the use of non-conductive artifacts.

What is claimed is:

1. A heater for steam production that comprises at least one nonconducting ceramic artifact and at least one conducting element wherein the at least one nonconducting ceramic artifact is positioned at least partially outside of the at least one conducting element.

2. The heater for steam production of claim 1 comprising a volume; wherein the heater is comprised of a volume ratio of the at least one ceramic artifact to the volume of the heater of up to 90%.

3. The heater for steam production of claim 1 wherein the at least one conducting element is non-spherical in cross-section.

4. The heater for steam production of claim 1 wherein the at least one nonconducting artifact is continuous or discontinuous with shapes from the list including spheres, cylinders, platonic solid and tessellations.

5. The heater for steam production of claim 1 wherein the at least one nonconducting ceramic artifact is positioned in contact and around the at least one conducting element and wherein the at least one nonconducting artifact is free-floating with respect to the at least one conducting element and wherein the at least one nonconducting artifact offers no structural or spatial function to the at least one conducting element.

6. The heater for steam production of claim 1 wherein the at least one nonconducting artifact is comprised of a surface texture that prevents CHF conditions.

7. The heater for steam production of claim 1 wherein the at least one conducting element is comprised of a surface texture or composition that prevents CHF conditions.

8. The heater for steam production of claim 1 wherein the at least one conducting element is comprised of metallic material or alloy and wherein the metallic material contains at least one element from the list comprising aluminum, iron, nickel, copper, carbon, chromium, tantalum, titanium and cobalt.

9. The heater for steam production of claim 1 wherein the at least one conducting element is comprised of a semiconductor.

10. The heater for steam production of claim 1 wherein the nonconducting artifact is comprised of a material from the list of oxides, nitrides, phosphides, sulfides, carbides, carbonitrides, oxycarbides and alloys wherein the metallic material contains at least one the metals from the list of aluminum, iron, nickel, copper, carbon, chromium, tantalum, titanium, cobalt, and semiconductor.

11. The heater for steam production of claim 1 wherein the at least one conducting element or at least one nonconducting artifact comprises porosity ranging from 1-40%.

12. The heater for steam production of claim 1 comprised in of a boiler.

13. A method for the controlling of CHF limitation in steam generation comprised of configuring a heater for steam production with at least one conducting element and at least one nonconducting artifact wherein the nonconducting artifact is positioned at least partially around the conducting element.

14. The method of claim 13 wherein the volume occupied by the nonconducting material exceeds the volume occupied by the conducting material.

15. A method for making high-temperature steam above saturation temperature comprised of configuring a heater for steam production with at least one conducting element and at least one nonconducting artifact and a conductive heater area in contact with a fluid wherein a volume occupied by the at least one nonconducting artifact ranges from 0.1 to 10 times of a volume of the fluid to be vaporized or transformed.

16. The method of claim 15 wherein the conductive heater area in contact with the fluid is less than 0.93 square meters.

17. The heater for steam production of claim 1 wherein the at least one nonconducting element is comprised of a chemistry that acts to soften water or remove conductive ions from the water.

18. The heater for steam production of claim 1 wherein the at least one conducting element and at least one nonconducting artifact are comprised of a chemistry that act to chemically modify fluid or steam.
